(19) United States
(12) Patent Application Publication
(10) Pub. No.: US 2021/0211034 A1
(43) Pub. Date: Jul. 8, 2021

(54) DEVICES FOR POWER MULTIPLICATION DURING ELECTROMECHANICAL ENERGY CONVERSION

(71) Applicant: Alexander Burov, Irkutsk (RU)

(72) Inventor: Alexander Burov, Irkutsk (RU)

(21) Appl. No.: 17/056,433

(22) PCT Filed: Jun. 25, 2018
(86) PCT No.: PCT/IB2018/054652

§ 371 Date: Nov. 18, 2020

(51) Int. Cl. H02K 53/00; H02K 11/00

(52) U.S. Cl. CPC H02K 53/00; H02K 11/00

(57) ABSTRACT

Output power of any electric machine is generally less than input power since some part of input power is always lost during electromechanical energy conversion process due to various mechanical and electrical losses. However, reluctance machines can be actually designed to have much lower input power in comparison to output power, even despite mechanical and electrical losses have not eliminated. Essentially, such devices provide power multiplication during electromechanical energy conversion. This is achieved due to design features of stator windings.

### FIELD OF THE INVENTION

The present invention relates generally to electric machines and, more particularly, to reluctance motors and generators.

### BACKGROUND OF THE INVENTION

Electric motors and electric generators are widely used for electromechanical energy conversion. Electric machines generally comprise a rotor, a stator, and windings that generate a torque between said rotor and said stator. This torque provides the rotor motion in the electric motor and opposes the rotor motion in the electric generator. Said torque can be electromagnetic or reluctance depending on the design of electric machine.

Most of electric machines has windings (or permanent magnets) attached to both the rotor and the stator, so the rotor and the stator can have their own magnetic fields. Interaction between magnetic fields results in electromagnetic torque generation. Reluctance machines generate reluctance torque instead of electromagnetic torque due to design features. Like many other electric machines, any reluctance machine comprises a rotor and a stator that are made of material with low coercivity (soft magnetic material, such as laminated silicon steel), but there are no windings or permanent magnets attached to the rotor, so it does not have its own magnetic field. The rotor aligns itself with a magnetic flux generated by stator windings to let said magnetic flux follow the path of least magnetic reluctance.

Existing electromechanical energy converters are not perfect—some part of input power is always lost during energy conversion process due to various mechanical and electrical losses. Engineers from all over the world try to reduce or eliminate these losses in order to increase energy conversion efficiency of electric machines. However, even complete elimination of all losses will not allow the output power to exceed the input power. The present invention reveals that reluctance machines can be actually designed to have much lower input power in comparison to output power, even despite mechanical and electrical losses have not eliminated.

### DETAILED DESCRIPTION OF THE INVENTION

Stator windings of any reluctance machine work essentially the same way as electromagnet attracting a piece of steel. The force of attraction is proportional to the square of the magnetic flux generated by the electromagnet:

$$F = \frac{{Φ}^{2}}{2 {μ}_{0} A} \qquad ( 1 )$$

where F is the force, Φ is the magnetic flux, μ₀ is the magnetic constant, and A is the cross-sectional area of the core.

The magnetic flux depends on the inductance and the electric current:

Φ=LI (2)

where Φ is the magnetic flux, L is the inductance, and I is the electric current.

The inductance is completely independent of energy consumption—it only depends on the size and the number of turns of the winding, and also the magnetic permeability of the core material:

$$L = \frac{{μ}_{0} μ {An}^{2}}{l} \qquad ( 3 )$$

where L is the inductance, μ₀ is the magnetic constant, μ is the magnetic permeability of the core, A is the cross-sectional area of the core, n is the number of turns of the winding, and l is the length of the winding.

By varying the inductance, it is possible to increase or decrease the input power of the electromagnet without changing the magnetic flux, as well as increase or decrease the magnetic flux without changing the input power. This means the input power of any reluctance machine can be less than the output power when stator windings are properly designed. Reluctance motors should be designed to have as high as possible inductance of stator windings as this decreases the electric current thus providing the lowest possible electrical input power. Reluctance generators should be designed to have as low as possible inductance of stator windings as this decreases the magnetic flux thus providing the lowest possible mechanical input power.

Any reluctance machine can be modified easily by windings replacement either on the development or the production stage since there is no need to change the rotor and the stator. It is only required to know the number of turns of the initial winding, and the cross-sectional area (or the diameter) of the initially used wire to calculate the parameters of the new winding. Detailed description and equations (where subscript “1” relates to the initial winding and subscript “2” relates to the new winding) are provided below.

Reluctance motors can be powered by DC (switched reluctance motor—SRM) or AC (synchronous reluctance motor—SynRM). The following method is applicable to both the SRM and the SynRM. It is important to note that any modified reluctance motor can use the same power source as before since there is no need to change the voltage or the frequency. To modify the reluctance motor, it is necessary to increase the number of turns of each stator winding. The cross-sectional area of the whole winding should remain unchanged, so it is necessary to select a thinner wire for the new winding and then calculate the required number of turns. The proportionality coefficient k will help:

$$k = \frac{{A}_{1}}{{A}_{2}} = {( \frac{{d}_{1}}{{d}_{2}} )}^{2} = \frac{{n}_{2}}{{n}_{1}} \qquad ( 4 )$$

where k is the proportionality coefficient, A is the cross-sectional area of the wire, d is the diameter of the wire, and n is the number of turns of the winding.

The cross-sectional area of the selected wire is k times less than the cross-sectional area of the initial wire, so the number of turns of the new winding has to be k times greater than the number of turns of the initial winding. The wire should be as thin as possible to maximize the effect of modification. It is also advised to select the wire such that the proportionality coefficient k can be expressed by a natural number.

The inductance is proportional to the square of the number of turns, so the inductance of the new winding is k² times greater than the inductance of the initial winding:

$${L}_{1} = \frac{{μ}_{0} μ {An}_{1}^{2}}{l} ⇒ {L}_{2} = {k}^{2} {L}_{1} = \frac{{μ}_{0} μ {A ( {kn}_{1} )}^{2}}{l} = \frac{{μ}_{0} μ {An}_{2}^{2}}{l} \qquad ( 5 )$$

where L is the inductance, μ₀ is the magnetic constant, μ is the magnetic permeability of the core, A is the cross-sectional area of the core, n is the number of turns of the winding, l is the length of the winding, and k is the proportionality coefficient.

Since the cross-sectional area of the new wire is k times less than before, and the length of the new wire is k times greater than before (as the length is proportional to the number of turns), the electrical resistance of the new winding is k² times greater than the electrical resistance of the initial winding:

$${R}_{1} = \frac{ρ {l}_{1}}{{A}_{1}} ⇒ {R}_{2} = {k}^{2} {R}_{1} = \frac{ρ ( {kl}_{1} )}{( {A}_{1} / k )} = \frac{ρ {l}_{2}}{{A}_{2}} \qquad ( 6 )$$

where R is the electrical resistance, ρ is the electrical resistivity, l is the length of the wire, A is the cross-sectional area of the wire, and k is the proportionality coefficient.

The time constant is the same as before:

$$T = \frac{{L}_{1}}{{R}_{1}} = \frac{( {k}^{2} {L}_{1} )}{( {k}^{2} {R}_{1} )} = \frac{{L}_{2}}{{R}_{2}} \qquad ( 7 )$$

where τ is the time constant, L is the inductance, R is the electrical resistance, and k is the proportionality coefficient.

For DC circuit there is no distinction between the electrical resistance and the electrical impedance since the angular frequency equals zero. As for AC circuit, the electrical reactance of the new winding is k² times greater than the electrical reactance of the initial winding:

X₁=ωL₁⇒X₂=k²X₁=ω(k²L₁)=ωL₂ (8)

where X is the electrical reactance, ω is the angular frequency, L is the inductance, and k is the proportionality coefficient.

The electrical impedance of the new winding is k² times greater than the electrical impedance of the initial winding:

$${Z}_{1} = \sqrt{{R}_{1}^{2} + {X}_{1}^{2}} ⇒ \\ ⇒ {Z}_{2} = {k}^{2} {Z}_{1} = \sqrt{{( {k}^{2} {R}_{1} )}^{2} + {( {k}^{2} {X}_{1} )}^{2}} = \sqrt{{R}_{2}^{2} + {X}_{2}^{2}} \qquad ( 9 )$$

where Z is the electrical impedance, R is the electrical resistance, X is the electrical reactance, and k is the proportionality coefficient.

Since the voltage of the power source has not changed, the electric current in the new winding is k² times less than the electric current in the initial winding:

$${I}_{1} = \frac{U}{{Z}_{1}} ⇒ {I}_{2} = \frac{{I}_{1}}{{k}^{2}} = \frac{U}{( {k}^{2} {Z}_{1} )} = \frac{U}{{Z}_{2}} \qquad ( 10 )$$

where I is the electric current, U is the voltage, Z is the electrical impedance, and k is the proportionality coefficient.

The electric current density in the new winding is k times less than the electric current density in the initial winding:

$${J}_{1} = \frac{{I}_{1}}{{A}_{1}} ⇒ {J}_{2} = \frac{{J}_{1}}{k} = \frac{( {I}_{1} / {k}^{2} )}{( {A}_{1} / k )} = \frac{{I}_{2}}{{A}_{2}} \qquad ( 11 )$$

where J is the electric current density, I is the electric current, A is the cross-sectional area of the wire, and k is the proportionality coefficient.

The electrical power of the new winding is k² times less than the electrical power of the initial winding:

$${P}_{E 1} = {UI}_{1} ⇒ {P}_{E 2} = \frac{{P}_{1}}{{k}^{2}} = U ( \frac{{I}_{1}}{{k}^{2}} ) = {UI}_{2} \qquad ( 12 )$$

where P_{E} is the electrical power, U is the voltage, I is the electric current, and k is the proportionality coefficient.

The magnetic flux is the same as before:

$$Φ = {L}_{1} {I}_{1} = ( {k}^{2} {L}_{1} ) ( \frac{{I}_{1}}{{k}^{2}} ) = {L}_{2} {I}_{2} \qquad ( 13 )$$

where Φ is the magnetic flux, L is the inductance, I is the electric current, and k is the proportionality coefficient.

The speed of electric motors is limited by the back-EMF (electromotive force) that is usually generated due to relative motion between stator windings and the magnetic field of the rotor. Such back-EMF is proportional to the number of turns of the winding, so increasing the number of turns proportionally decreases the speed of the motor. Reluctance motors do not generate back-EMF this way since the rotor does not have its own magnetic field—the back-EMF is self-induced by stator windings due to variation of the magnetic flux since the magnetic reluctance varies with position of the rotor. This back-EMF depends on the magnetic flux and the rate of its variation, and is completely independent of the number of turns of the winding. The speed of the modified reluctance motor remains unchanged since the back-EMF is the same as before:

$$ɛ = - \frac{ΔΦ}{Δ t} \qquad ( 14 )$$

where ε is the electromotive force, Φ is the magnetic flux, and t is the time.

According to the equation 1, the force (the torque) of the modified reluctance motor remains unchanged because the magnetic flux is the same as before. Since the force and the speed have not changed, the mechanical output power of the modified reluctance motor remains unchanged:

P_{M}=Fv (15)

where P_{M} is the mechanical power, F is the force, and v is the velocity.

After the windings replacement, the reluctance motor has the same mechanical output power as before modification but consumes k² times less electrical input power. The output power exceeds the input power but mechanical and electrical losses have not eliminated, so energy conversion efficiency is actually below 100%. It is necessary to use the coefficient of performance K in addition to the energy conversion efficiency η to solve this problem:

P_{OUT}=k²¹ηP_{IN}=KηP_{IN} (16)

where R_{OUT} is the output power, P_{IN} is the input power, n is the energy conversion efficiency, k is the proportionality coefficient, and K is the coefficient of performance.

The energy conversion efficiency η is always less than 1 and the coefficient of performance K is always greater than 1.

The equation 16 shows the operation principle of modified reluctance machines—power multiplication during electromechanical energy conversion, so the coefficient of performance K can also be called the power multiplication coefficient. Since electric machines are electromechanical energy converters, any modified reluctance machine can be called the multiplying electromechanical energy converter (MEMEC), and any modified reluctance motor can be called the multiplying electric motor (MEM).

The method described above should be applied to reluctance motors only. As an example, modification of brushless DC motor (BLDC) with permanent magnets can be considered. The electrical input power of the BLDC can be reduced k² times the same way as the electrical input power of the reluctance motor. Unfortunately, the mechanical output power of the modified BLDC will be reduced too. The torque of the BLDC is proportional to the electric current and the number of turns of the winding. Since the number of turns of the winding will be k times greater than before and the electric current will be k² times less than before, the torque of the modified BLDC will be reduced k times. The back-EMF is proportional to the number of turns of the winding, so the speed of the modified BLDC will be decreased k times. The mechanical output power of the modified BLDC will be k² times less than before, so such modification is pointless.

The slightly changed method can be applied to reluctance generators (such as switched reluctance generator—SRG) to create the multiplying electric generator (MEG). To modify the reluctance generator, it is necessary to decrease the number of turns of each stator winding. The cross-sectional area of the whole winding should remain unchanged, so it is necessary to select a thicker wire for the new winding and then calculate the required number of turns. The proportionality coefficient k will help:

$$k = \frac{{A}_{2}}{{A}_{1}} = {( \frac{{d}_{2}}{{d}_{1}} )}^{2} = \frac{{n}_{1}}{{n}_{2}} \qquad ( 17 )$$

where k is the proportionality coefficient, A is the cross-sectional area of the wire, d is the diameter of the wire, and n is the number of turns of the winding.

The cross-sectional area of the selected wire is k times greater than the cross-sectional area of the initial wire, so the number of turns of the new winding has to be k times less than the number of turns of the initial winding. The wire should be as thick as possible to maximize the effect of modification (stranded wire can be used). It is also advised to select the wire such that the proportionality coefficient k can be expressed by a natural number.

The inductance is proportional to the square of the number of turns, so the inductance of the new winding is k² times less than the inductance of the initial winding:

$${L}_{1} = \frac{{μ}_{0} μ {An}_{1}^{2}}{l} ⇒ {L}_{ 2} = \frac{{L}_{1}}{{k}^{2}} = \frac{{μ}_{0} μ {A ( {n}_{1} / k )}^{2}}{l} = \frac{{μ}_{0} μ {An}_{2}^{2}}{l} \qquad ( 18 )$$

where L is the inductance, μ₀ is the magnetic constant, μ is the magnetic permeability of the core, A is the cross-sectional area of the core, n is the number of turns of the winding, l is the length of the winding, and k is the proportionality coefficient.

Since the cross-sectional area of the new wire is k times greater than before, and the length of the new wire is k times less than before (as the length is proportional to the number of turns), the electrical resistance of the new winding is k² times less than the electrical resistance of the initial winding:

$${R}_{1} = \frac{{ρl}_{1}}{{A}_{1}} ⇒ {R}_{2} = \frac{{R}_{1}}{{k}^{2}} = \frac{ρ ( {l}_{1} / k )}{( {kA}_{1} )} = \frac{ρ {l}_{2}}{{A}_{2}} \qquad ( 19 )$$

where R is the electrical resistance, ρ is the electrical resistivity, l is the length of the wire, A is the cross-sectional area of the wire, and k is the proportionality coefficient.

The time constant is the same as before:

$$τ = \frac{{L}_{1}}{{R}_{1}} = \frac{( {L}_{1} / {k}^{2} )}{( {R}_{1} / {k}^{2} )} = \frac{{L}_{2}}{{R}_{2}} \qquad ( 20 )$$

where τ is the time constant, L is the inductance, R is the electrical resistance, and k is the proportionality coefficient.

The excitation power should remain unchanged, so the excitation voltage has to be decreased k times:

$${P}_{E} = \frac{{U}_{1}^{2}}{{R}_{1}} = \frac{{( {U}_{1} / k )}^{2}}{( {R}_{1} / {k}^{2} )} = \frac{{U}_{2}^{2}}{{R}_{2}} \qquad ( 21 )$$

where P_{E} is the electrical power, U is the voltage, R is the electrical resistance, and k is the proportionality coefficient.

The electric current in the new winding is k times greater than the electric current in the initial winding:

$${I}_{1} = \frac{{U}_{1}}{{R}_{1}} ⇒ {I}_{2} = {kI}_{1} = \frac{( {U}_{1} / k )}{( {R}_{1} / {k}^{2} )} = \frac{{U}_{2}}{{R}_{2}} \qquad ( 22 )$$

where I is the electric current, U is the voltage, R is the electrical resistance, and k is the proportionality coefficient.

The electric current density is the same as before:

$$J = \frac{{I}_{1}}{{A}_{1}} = \frac{( {kI}_{1} )}{( {kA}_{1} )} = \frac{{I}_{2}}{{A}_{2}} \qquad ( 23 )$$

where J is the electric current density, I is the electric current, A is the cross-sectional area of the wire, and k is the proportionality coefficient.

The magnetic flux of the new winding is k times less than the magnetic flux of the initial winding:

$${Φ}_{1} = {L}_{1} {I}_{1} ⇒ {Φ}_{2} = \frac{{Φ}_{1}}{k} = \frac{( {L}_{1} )}{( {k}^{2} )} ( {kI}_{1} ) = {L}_{2} {I}_{2} \qquad ( 24 )$$

where Φ is the magnetic flux, L is the inductance, I is the electric current, and k is the proportionality coefficient.

The EMF (the output voltage) of the reluctance generator is proportional to the magnetic flux and the rate of its variation. Since the rotor speed has not changed, the output voltage of the modified reluctance generator is k times less than before:

$${ɛ}_{1} = - \frac{{ΔΦ}_{1}}{Δ t} ⇒ {ɛ}_{2} = \frac{{ɛ}_{1}}{k} = - \frac{Δ ( {Φ}_{1} / k )}{Δ t} = - \frac{{ΔΦ}_{2}}{Δ t} \qquad ( 25 )$$

where ε is the electromotive force, Φ is the magnetic flux, t is the time, and k is the proportionality coefficient.

The electrical output power of the modified reluctance generator is the same as before:

$${P}_{E} = {U}_{1} {I}_{1} = ( \frac{{U}_{1}}{k} ) ( {kI}_{1} ) = {U}_{2} {I}_{2} \qquad ( 26 )$$

where P_{E} is the electrical power, U is the voltage, I is the electric current, and k is the proportionality coefficient.

The force (the torque) required to keep the rotor speed is k² times less than before:

$${F}_{1} = \frac{{Φ}_{1}^{2}}{2 {μ}_{0} A} ⇒ {F}_{2} = \frac{{F}_{1}}{{k}^{2}} = \frac{{( {Φ}_{1} / k )}^{2}}{2 {μ}_{0} A} = \frac{{Φ}_{2}^{2}}{2 {μ}_{0} A} \qquad ( 27 )$$

where F is the force, Φ is the magnetic flux, μ₀ is the magnetic constant, A is the cross-sectional area of the core, and k is the proportionality coefficient.

Since the rotor speed has not changed, the mechanical input power is k² times less than before:

$${P}_{M 1} = {F}_{1} v ⇒ {P}_{M 2} = \frac{{P}_{M 1}}{{k}^{2}} = ( \frac{{F}_{1}}{{k}^{2}} ) v = {F}_{2} v \qquad ( 28 )$$

where P_{M} is the mechanical power, F is the force, v is the velocity, and k is the proportionality coefficient.

After the windings replacement, the reluctance generator has the same electrical output power as before modification but requires k² times less mechanical input power. The output power exceeds the input power but mechanical and electrical losses have not eliminated, so energy conversion efficiency is actually below 100%. It is necessary to use the equation 16 to determine the efficiency of the modified reluctance generator properly.

Multiplying electric motors and multiplying electric generators can be used instead of conventional electric machines for much more efficient electromechanical energy conversion. They also can be a part of a system that can be called the electromechanical power multiplier (EMPM) since it provides electrical power multiplication by double electromechanical energy conversion.

Said system comprises at least two electromechanical energy converters—an electric motor and an electric generator, and at least one of said converters is the multiplying electromechanical energy converter. The system also comprises means for mechanical energy transmission from the electric motor to the electric generator made such that said electric generator is a mechanical load for said electric motor, and means for electrical energy transmission from the electric generator to the electric motor made such that said electric motor is an electrical load for said electric generator. In other words, the electric motor and the electric generator are mechanically and electrically coupled together. The output power of the electric generator should be several times greater than the input power of the electric motor.

The operation principle is simple—the electric motor converts electrical energy into mechanical energy, and then the electric generator converts mechanical energy back into electrical energy. Small part of the output power of said electric generator supplies said electric motor, and the other part of the output power can be used to supply any external electrical load.

The electromechanical energy multiplier can be started by either connecting the electric motor to an external power source or launching the electric generator mechanically. Then the external power source should be disconnected since the electromechanical energy multiplier is itself a power source. However, a rechargeable battery (or a capacitor) can be connected in parallel to the electric generator as this provides an opportunity to stop the electromechanical energy multiplier if there is no external load, and then re-start it when necessary.

Possibilities of using the electromechanical energy multiplier are endless: electric vehicles with unlimited range, houses and factories that do not require connection to electric power grid, etc. Highly efficient and completely autonomous power source that works without fuel, wind or sunlight and does not pollute the environment is a dream that have come true.

1. An electromechanical energy converter, comprising:
a rotor made of material with low coercivity;
a stator made of material with low coercivity; and
stator windings capable of generating reluctance torque between said rotor and said stator,
characterized in that an input power is less than an output power due to design features of said windings.

2. A system for electrical power multiplication by double electromechanical energy conversion, comprising:
at least two electromechanical energy converters—an electric motor and an electric generator, and at least one of said converters is the electromechanical energy converter of claim 1;
means for mechanical energy transmission from the electric motor to the electric generator made such that said electric generator is a mechanical load for said electric motor; and
means for electrical energy transmission from the electric generator to the electric motor made such that said electric motor is an electrical load for said electric generator.

3. The system for electrical power multiplication of claim 2, further comprising a rechargeable battery (or a capacitor) connected in parallel to said electric generator to provide a re-start capability.
